(19) United States
(12) Patent Application Publication
(10) Pub. No.: US 2007/0152411 A1
(43) Pub. Date: Jul. 5, 2007

(54) Trash receptacle utility cart

(76) Inventors: John E. Lox, East Alton, IL (US); Fred Childers, South Roxana, IL (US)

Correspondence Address: Raymond M. Galasso;Galasso & Associates LP, P.O. Box 26503, Austin, TX, 78755-0503, US

(21) Appl. No.: 11/321,805

(22) Filed: Dec. 29, 2005

(51) Int. Cl. B62B 1/00

(52) U.S. Cl. 280/47.17

(57) ABSTRACT

A utility cart designed to accommodate two trash receptacles therein. The utility cart includes a platform area comprising a floor and floor support members peripherally secured thereto. The cart further includes four corner posts with a plurality of cross members interposed therewith. A pair of retaining arms is pivotally secured to one of the corner posts. The utility cart further includes a hingedly mounted handle and a pair of wheels and a hitch receiver.

### FIELD OF THE INVENTION

The present invention relates to carts, and more specifically but not by way of limitation to a utility cart that is designed to receive a plurality of standard trash receptacles and configures to facilitate the movement and storage of the trash receptacles. The cart is further configured to engage with a variety of anchors to secure the cart to prevent the cart from tipping and to prevent the theft of the cart.

### BACKGROUND

Individuals commonly use standard trash receptacles around their homes to collect different types of refuse. Household trash is collected in these conventional containers which are usually made of a lightweight material such as aluminum or plastic. The trash receptacles are light weight so that once the receptacle is loaded with refuse, it can be easily managed by the owner in order to transport the load trash receptacle to the street for collection by a municipal waste management company.

The light weight of the standard trash receptacle creates several problems. The trash receptacles are prone to be knocked over during any substantial storm or on a windy day thereby releasing some or all of the trash contained therein. This creates an undesirable and unsanitary situation as the owner must collect the trash that has been strewn over the street and yard.

Another issue involves animals. Whether domestic or wild, the lightweight receptacles are easily tipped over and rummaged through by a neighborhood dog or other animal. This again results in an undesirable situation where the trash within the trash receptacle has become strewn across the yard and street whereby the owner must re-collect the trash and place in the receptacle.

Another issue with standard trash receptacles involves the transportation thereof. Typically, a homeowner will have at least two trash receptacles that must be transported to the street for collection. Moving two or more loaded trash receptacles can be a cumbersome challenge.

Accordingly there is a need for a device that facilitates the storage of a plurality of standard trash receptacle which secures the trash receptacles and maintains the trash receptacles in an upright position under all adverse weather conditions. The device should further be equipped to aid in the transportation of the plurality of trash receptacles.

### SUMMARY OF THE INVENTION

It is an object of the present invention to provide a device that releasably secures a plurality of trash receptacles and maintains them in an upright position during adverse weather conditions.

It is another object of the present invention to provide a device that facilitates the transportation of a plurality of standard trash receptacles.

It is a further object of the present invention to provide a device that secures a plurality of trash receptacles in an upright position and facilitates the transportation thereof and further includes a retaining mechanism that secures the device to a suitable horizontal support structure.

Yet another object of the present invention is to provide a device that secures a plurality of trash receptacles in an upright position and facilitates the movement thereof that is lightweight and easy to use.

Another object of the present invention is to provide a device that secures a plurality of trash receptacles in an upright position and facilitates the movement thereof that can be releasably secured to a standard yard tractor.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a perspective view of an embodiment of the present invention;

FIG. 2 is a perspective view of an embodiment of a hitch receiver and shank with locking pin suitable for use with the present invention;

FIG. 3 is a perspective view of the anchors and lock pin that secure the present invention to a suitable horizontal support structure; and

FIG. 4 is a detailed view of a retaining arm releasably secured to the corner post of the present invention.

### DETAILED DESCRIPTION

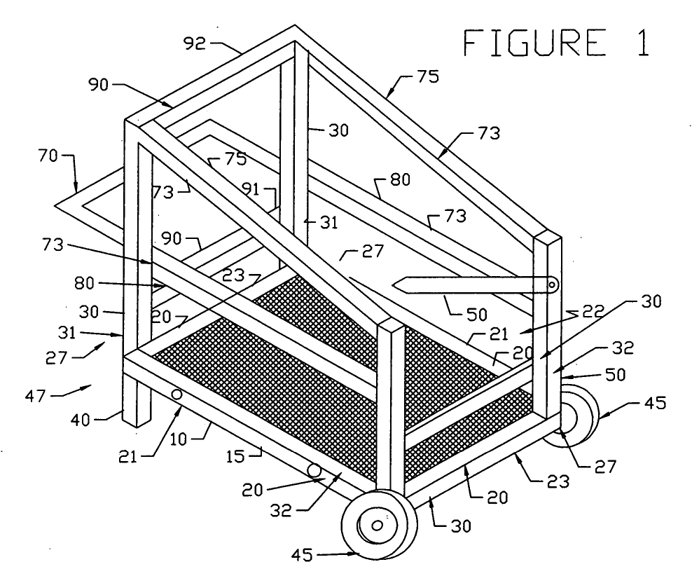

Referring now to the drawings, wherein various elements depicted are not necessarily drawn to scale and wherein like reference numerals are used throughout the Figures, and in particular FIGS. 1 through 4, there is illustrated a utility cart 100 and its components constructed according to the principles of the present invention.

The utility cart 100 comprises a floor 10 configured in a substantially planar manner and generally rectangular in shape. The floor 10 is constructed of a suitable rigid material such as but not limited to wire mesh so as to prevent the collection of debris and liquid. Although no particular size of wire mesh is required, good results have been achieved with a sheet of one inch wire mesh. Circumferentially disposed around the peripheral edge 15 of the floor 10 are floor support members 20. The floor support members 20 are manufactured from square tubing such as but not limited to aluminum tubing. The floor support members 20 function to provide structural support for the floor 10. There are two side floor support members 21 mounted on opposing sides of the floor. 10 and two end floor support members 23 mounted on opposing sides of the floor 10 interposed the ends of the side floor support members 21. The floor support members 20. are mechanically fastened superposed to the floor 10 by conventional methods such as but not limited to welding.

The floor support members 20 and the floor 10 function to define the platform area 22 on which objects are to be placed to be releasably secured by the utility cart 100. Although no specific measurement is required, good results have been achieved with side floor support members 21 that are approximately forty-eight inches in length. Furthermore, good results have also been achieved with end floor support members 23 that are approximately 28 inches in length. Those skilled in the art will recognize that numerous different shapes of tubing could be used in place of and/or in conjunction with the tubing referenced herein to construct the floor support members 20 and achieve the desired functionality. It should be further recognized that the platform area 22 could be manufactured in numerous different shapes and achieve the desired functionality.

Superposed on each corner 27 of platform area 22 are corner posts 30. The corner posts 30 are manufactured from square tubing such as but not limited to aluminum. The corner posts 30 are oriented in a vertical manner extending upwardly from the platform area 22. Although no specific length is required, good results have been achieved with corner posts 30 that are approximately thirty eight inches in length for the rear corner posts 31 and thirty two inches for the two front corner posts 32. The corner posts 30 are mechanically secured proximate their first end to the corners 27 of the platform area 22 by conventional mechanical methods such as but not limited to welding.

Interposed the corner posts 30 are four side retaining members 73. Two lower side retaining members 80 are mounted intermediate the front corner post 32 and the rear corner post 31 on opposing sides of the platform area 22 and are configured in a horizontal manner. The lower side retaining members 80 are manufactured from square metal tubing or other suitable durable rigid materials and are conventional secured by mechanical methods such as bolts or welding. Although no specific attachment point is required, good results have been achieved whereby the lower side retaining member 80 is secured five and three/quarters of an inch below the second end of the front corner posts 32 and nine and a half inches below the second end of the rear corner posts 31.

Distally secured to the second ends of the front corner posts 32 and the rear corner posts 31 on opposing sides are two upper side retaining members 75. The upper side retaining members 75 are manufactured from a durable rigid material such as but not limited to square metal tubing. The upper side retaining members 75 are secured to the second ends of the corner posts 30 with conventional mechanical methods such as welding. The upper side retaining members 75 are configured in an angular manner sloping downward from the rear corner posts 31 towards the front corner posts 32.

Integrally mounted with the rear corner posts 31 and contiguous therewith are the rear legs 40. The rear legs 40 are mounted beneath the floor 10 and function to support the utility cart 100 above the ground. The rear legs 40 are manufactured from a suitable durable material such as metal tubing and are mechanically fastened to the first end of the rear corner posts 31 by conventional methods such as welding. It is also contemplated within the scope of the present invention that the rear corner posts 31 are mounted such that a portion thereof extends beneath the floor thereby creating a leg portion that would function to support the rear end 47 of the cart above the ground.

Mounted intermediate the two rear corner posts 31 and configured in a horizontal manner is are two rear retaining members 90. A lower rear retaining member 91 is mounted above the platform area 22 and secured approximately parallel with the lower side retaining members 80. The lower rear retaining member 91 is manufactured from square metal tubing or other suitable durable rigid material. Interposed to the second end of the rear corner posts 31 and perpendicular thereto is an upper rear retaining member 92. The upper retaining member 92 is secured by conventional mechanical methods such as but not limited to welding.

Hingedly mounted to the rear corner posts 31 distal to the floor and generally above the lower rear retaining member 91 is a handle 70. The handle 70 is manufactured from a durable rigid material such as metal or plastic. The handle 70 is a square u-shaped bar with opposing ends that are conventionally secured to the rear corner posts 31 with a standard hinge mechanism. The handle 70 is moved into its second position whereby the handle 70 is generally perpendicular to the rear corner posts 31. In its second position, the user can leverage the handle 70 to lift the utility cart in an upwards direction thereby preparing the utility cart for transportation by disengaging the rear legs 40 with the ground. Although no specific length is required, good results have been achieved with a handle 70 that is approximately sixteen inches in length. Although the handle is illustrated in the drawings submitted herewith as being generally a square u-shaped handle, it is further contemplated within the scope of the present invention that the handle 70 could be a single bar that is mounted to one of the two rear corner posts 31. Furthermore, the handle 70 could have disposed substantially thereon a durable foam material to facilitate a more comfortable grip for the user of the utility cart 100. Those skilled in the art will recognize that numerous different shapes of tubing could be used to manufacture the handle and perform the desired function as described herein.

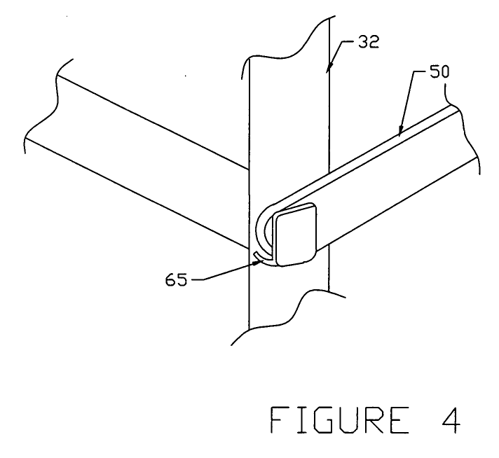

Pivotally mounted on one of the front corner posts 32 are a pair of retaining arms 50. The retaining arms 50 have first ends that are pivotally mounted on the same front corner post 50. As shown in particular in FIG. 4, mounted on the opposing front corner post 32 is a pair of retaining arm clips 65. The retaining arm clips 65 are L-shaped brackets that are designed to receive and support therein the second end of the retaining arms 50. The retaining arm clips 65 are secured to the front corner posts 32 by conventional mechanical methods such as but not limited to welding. The user will pivot the retaining arms 50 out of their first position whereby the retaining arms 50 will be oriented in a perpendicular manner with respect to the front corner posts 32 and secure the second end of the retaining arms 50 into the retaining arm clip 65. Although the utility cart 100 is illustrated as having two retaining arms 50, those skilled in the art should recognize that numerous different amounts of retaining arms 50 could be used to achieve the desired function described herein.

Mounted adjacent to the front corner posts 32 proximate to the platform area 22 are a pair of wheels 45. The wheels 45 are secured by conventional mechanical methods such as but not limited to bolts. The wheels 45 function to facilitate the transportation of the utility cart 100 when the handle 70 is leveraged in an upwards direction thereby disengaging the rear legs 40 from the ground. This position allows the user to roll the utility cart to the desired destination.

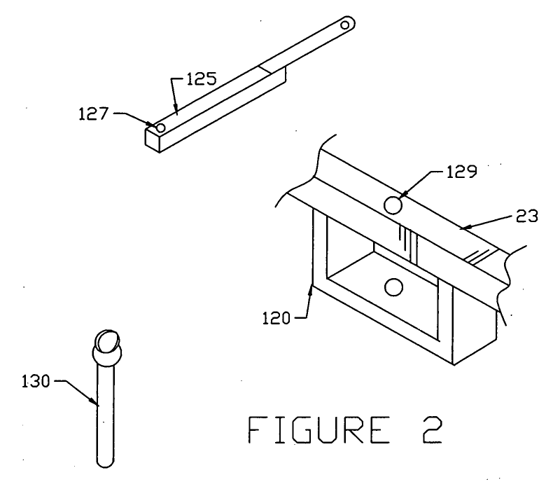

Now referring in particular to FIG. 2, secured beneath one of the end floor support members is a hitch receiver 120. The hitch receiver 120 is three sided bracket welded or secure by other suitable methods that is configured to receive therein a hitch shank 125. The hitch shank 125 is a square metal tube of sufficient size to be inserted into the hitch receiver 120. On one end of the hitch shank 125 an aperture 127 is present. This aperture 127 is of corresponding size to a hole 129 that is centrally located through the hitch receiver 120 and the adjacent end floor support member 23. Upon insertion of the hitch shank 125 into the hitch receiver 120 the hitch shank 125 is releasably secured into position by a standard locking pin 130 being inserted through the aperture 127 and the hole 129. Although no specific length is required, good results have been achieved with a locking pin 130 that is three inches in length. It is also contemplated within the scope of the present invention that the locking pin 130 has a bore located on one end being configured to receive a standard padlock therein. Opposite the aperture 127 the hitch shank 125 has fastened thereto a mounting plate 135 that is used to interface with utility vehicles such as but not limited to a yard tractor.

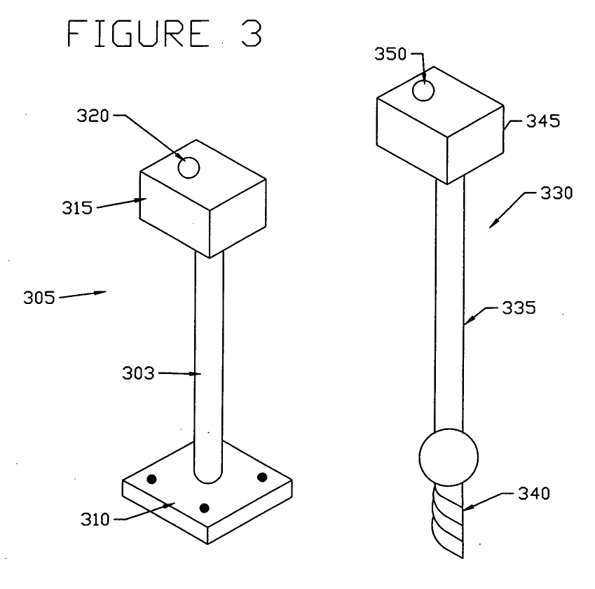

Now referring in particular to FIG. 3, there is illustrated anchors 300 that are designed to removably secure the utility cart 100 when it is stored. The concrete anchor 305 is a conventional mechanical anchor with a rod 303 that has mounted to one end a mounting plate 310 whereby the concrete anchor 305 can be mechanically fastened to a concrete surface. Distally located on the rod 303 from the mounting plate 310 is a mounting block 315. The mounting block 315 is of sufficient size to be inserted into the hitch receiver 120. The mounting block 315 has a bore 320 located therein to receive the locking pin 130 to facilitate secure storage of the utility cart.

Still referring to FIG. 3, a dirt anchor 330 is used to releasably secure the utility cart 100 to the ground. The dirt anchor 330 is a standard mechanical anchor that has a rod 335 with an auger bit 340 secured to one end of the rod 335. The auger bit 340 is facilitates the penetration of the dirt anchor 330 into the ground. Secured opposite the auger bit 340 superposed on the rod 335 by suitable methods such as welding is a mounting block 345. The mounting block 345 is of sufficient size to be inserted into the hitch receiver 120 of the utility cart. The mounting block 340 has a hole 350 disposed therein that is of sufficient size to accommodate the locking pin 130.

Now referring in particular to FIG. 1, a description of the operation of the utility cart 100 is as follows. The retaining arms 50 are placed in a first position whereby the retaining arms 50 are parallel with the front corner posts 32. The user then places the desired objects such as but not limited to trash receptacles on the floor 10 of the utility cart 100. The user then secures the trash receptacles in place by placing the retaining arms 50 into their second position whereby the second end of the retaining arms 50 are secured into the retaining arm clips 65. The user then proceeds to place the dirt anchor 330 into the ground adjacent to the area where the utility cart 100 will be stored. The utility cart 100 is positioned wherein the mounting block 345 of the dirt anchor 330 is inserted into the hitch receiver 120. The locking pin 130 is inserted to ensure the utility cart is secured into position. The user then proceeds to fill the trash receptacles with refuse. When the user desires to move the utility cart 100 by hand, the user removes the locking pin 130 from the mounting block 345 and hitch receiver 120 and lifts the handle 70 into its second position. The user then leverages against the handle 70 in an upwards direction releasing the legs 40 from the ground. The user can now roll the utility cart 100 on its wheels 45 to the desired location.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contract, it is intended to cover such alternatives, modifications, and equivalents, as can be reasonably included within the spirit and scope of the appended claims.

What is claimed is:

1. A utility cart configured to retain at least one trash can and assist in the transportation thereof comprising:
a platform, said platform being generally rectangular in shape having four corners, said platform further including a floor, said floor having floor support members peripherally disposed thereon;
four corner posts, said corner posts being secured adjacent to said four corners of said platform and extending in an upwards direction away from said floor;
at least two support members, said support member being horizontally interposed to said corner posts, said support members for retaining objects on said platform;
at least one retaining arm, said retaining arm pivotally mounted to one of said corner posts, said retaining arm having a first and a second end; and
at least one end rail, said end rail being mounted interposed said corner posts configured in a horizontal manner, said end rail further being mounted on the opposing side of said platform from said retaining arm.

2. The utility cart as recited in claim 1, and further including a retaining clip, said retaining clip being mounted to said corner posts opposite said retaining arm, said retaining clip being configured to receive therein the second end of said retaining arm.

3. The utility cart as recited in claim 2, and further including a handle, said handle being hingedly mounted interposed two of said corner posts opposite said retaining arm, said handle having a first and a second position, said handle being configured as an interface to facilitate the transportation of the utility cart.

4. The utility cart as recited in claim 3, and further including a pair of wheels, said wheels being mounted to said floor support members on opposing sides of said platform, said wheels for aiding in the transportation of said cart.

5. The utility cart as recited in claim 4, and further including two legs, said legs being mounted below said platform, said legs being secured to said platform distal to said wheels.

6. The utility cart as recited in claim 5, and further including a hitch receiver, said hitch receiver being secured to said floor support member, said hitch receiver being configured to receive a hitch shank therein.

7. The utility cart as recited in claim 6, wherein said floor is manufactured from wire mesh.

8. A utility cart configured to retain two standard trash cans and assist in the transportation thereof comprising:
a platform, said platform being rectangular in shape having four corners, said platform further including a floor, said floor having floor support members peripherally disposed on each side thereof;
four corner posts, said four corner post consisting of two front corner posts and two rear corner posts, said front corner posts and said rear corner posts being configured in a vertical manner extending upwardly from said floor;
four side support members, two of said side support members being mounted interposed to one of said rear corner posts and one of said front corner posts, two of said side support members being mounted interposed to the opposing rear corner post and front corner post; said side support members being configured to retain a trash can on said platform;
two retaining arms, said retaining arms having a first end and a second end, said first end of said retaining arms being pivotally mounted to one of said front corner posts, said retaining arm for releasably securing said trash cans on said platform, said retaining arms having a first and a second end;
two end rails, said end rails being mounted interposed said rear corner posts, said end rails being configured in a horizontal manner to retain said trash cans on said platform; and
two retaining clips, said retaining clips being mounted on said front corner post opposite said retaining arms, said retaining clips being configured to receive therein said second end of said retaining arm.

9. The utility cart as recited in claim 8, and further including a handle, said handle being hingedly mounted intermediate said rear corner posts, said handle having a first position wherein said handle is adjacent to said rear corner posts, said handle further having a second position wherein said handle is perpendicular to said rear corner posts, said handle being configured to provide leverage to transport said utility cart.

10. The utility cart as recited in claim 9, and further including two wheels, said wheels being mounted adjacent said platform opposite said handle.

11. The utility cart as recited in claim 10, and further including two legs, said legs being contiguous with said rear corner posts said legs extending downward from said platform.

12. The utility cart as recited in claim 11, and further including a hitch receiver, said hitch receiver being secured underneath said platform to said floor support member interposed said rear corner posts, said hitch receiver being configured to receive a hitch shank therein.

13. The utility cart as recited in claim 12, wherein said hitch receiver is further configured to receive therein a ground anchor, said ground anchor for securing said utility cart to the ground.

14. The utility cart as recited in claim 13, wherein said front corner posts are thirty two inches in length and said rear corner posts are thirty eight inches in length.

15. The utility cart as recited in claim 14, wherein said handle is sixteen inches in length.

16. A utility cart configured to retain two standard trash cans and assist in the transportation thereof comprising:
a platform, said platform being rectangular in shape having four corners, said platform further including a floor, said floor having floor support members peripherally disposed on each side thereof, said floor being manufactured from wire mesh, said platform being forty eight inches by twenty eight inches;
four corner posts, said four corner posts having a first end proximate said floor and a second end, said four corner posts consisting of two front corner posts and two rear corner posts, said front corner posts and said rear corner posts being configured in a vertical manner extending upwardly from said floor;
four side support members, said four side support members consisting of two lower side support members and two upper side support members, said lower side support members being opposedly mounted interposed in a horizontal manner to said front corner posts and said rear corner posts, said upper side support members being opposedly mounted interposed said front corner posts and said rear corner posts proximate said second ends of said four corner posts, said upper side support members being configured in an angular manner towards said front corner posts, said side support members being configured to retain two trash cans on said platform;
two retaining arms, said retaining arms having a first end and a second end, said first end of said retaining arms being pivotally mounted to one of said front corner posts, said retaining arm for releasably securing said trash cans on said platform, said retaining arm having a first and a second end;
two end rails, said end rails being mounted interposed said rear corner posts, said end rails being configured in a horizontal manner to retain said trash cans on said platform;
a handle, said handle being hingedly mounted intermediate said rear corner posts, said handle being having a first position wherein said handle is adjacent to said rear corner posts, said handle further having a second position wherein said handle is perpendicular to said rear corner posts, said handle being configured to provide leverage to transport said utility cart; and
two wheel, said wheels being opposedly mounted adjacent said platform proximate said front corner posts.

17. The utility cart as recited in claim 16, and further including a hitch receiver, said hitch receiver being mounted to said floor support member interposed said rear corner posts, said hitch receiver configured to receive a hitch shank therein.

18. The utility cart as recited in claim 17, wherein said hitch receiver is further configured to receive therein a ground anchor, said ground anchor for securing said utility cart to said ground.

19. The utility cart as recited in claim 18, wherein said rear corner posts are at least thirty eight inches in length and said front corner posts are at least thirty two inches in length.

20. The utility cart as recited in claim 19, wherein said handle is at least sixteen inches in length.
